(19) United States
(12) Patent Application Publication
(10) Pub. No.: US 2014/0169029 A1
(43) Pub. Date: Jun. 19, 2014

(54) BEADED CLEAR OPTICAL LAYERS FOR TURNING OR EXTRACTING LIGHT

(71) Applicant: 3M INNOVATIVE PROPERTIES COMPANY, ST. PAUL, MN (US)

(72) Inventors: Jane K. Wardhana, Jakarta Selatan (ID); Kevin R. Schaffer, Woodbury, MN (US); Audrey A. Sherman, St. Paul, MN (US)

(73) Assignee: 3M INNOVATIVE PROPERTIES COMPANY, ST. PAUL, MN (US)

(21) Appl. No.: 13/713,412

(22) Filed: Dec. 13, 2012

(51) Int. Cl. F21V 8/00; G02B 5/08; G02B 1/04

(52) U.S. Cl. CPC G02B 6/0055; G02B 1/04; G02B 5/08
USPC 362/606; 428/143; 359/884

(57) ABSTRACT

Optical films performing the function of turning or extraction are described. More specifically, beaded clear layers having first and second layers of pressure sensitive adhesive and a plurality of microspheres are described. In some embodiments, the thicknesses of the first and second layers of pressure sensitive adhesive and the diameter of the microspheres are selected such that the first and second layers of pressure sensitive adhesive are not in contact. In other embodiments, the index of refraction of the microspheres is selected to reflect light through total internal reflection. Optical films with beaded clear layers and light extraction layers are also described.

### BACKGROUND

Optical films which may function to selectively extract and to turn light are desirable in many applications. Selective extraction can provide increased uniformity to a film over its output area, particularly in applications including a light guide that is edge-lit. The selective extraction may counteract, through a gradient or otherwise, the natural drop in brightness as a function of distance from the light source. The turning of light (that is, the redirection of light from higher to lower angles or vice versa) may be desired in applications where light is otherwise outputted at unviewable or unusable angles. There is a need to provide this optical functionality with a low-haze and high transmission film for enhanced readability and clarity—perhaps for use in displays or other optical systems. Traditional lightguides may utilize printed dots to extract and turn the light, but such configurations are not transparent. Other transparent films use high-temperature processing or curing steps which limit the use of materials; may impart defects including stress, shrinking, and yellowing or other color defects; and may limit the flexibility of the film.

### SUMMARY

In one aspect, the present disclosure describes an optical film. In some embodiments, the optical film include as first layer of pressure sensitive adhesive having a first thickness, a second layer of pressure sensitive adhesive having a second thickness, and a plurality of microspheres having a mean diameter, the plurality of microspheres disposed between and at least partially within each of the first and second layers of pressure sensitive adhesive. The first thickness of the first layer of pressure sensitive adhesive, the second thickness of the second layer of pressure sensitive adhesive, and the mean diameter of the plurality of microspheres have been selected such that the first and second layers of pressure sensitive adhesive are not in contact.

In another aspect, the optical film of the present disclosure describes an optical film having a first layer of pressure sensitive adhesive, a second layer of pressure sensitive adhesive, and a plurality of microspheres having an index of refraction, the plurality of microspheres disposed between and at least partially within each of the first and second layers of pressure sensitive adhesive. In some embodiments, the index of refraction of the plurality of microspheres has been selected to reflect at least a portion of light incident on the light turning film through total internal reflection without entering the plurality of microspheres.

In yet another aspect, the optical film of the present disclosure includes an extraction layer having a first region and a second region, where the first region has a lower effective index of refraction than the second region, and a turning layer optically coupled to the extraction layer. In some embodiments, the turning layer includes a first layer of pressure sensitive adhesive, a second layer of pressure sensitive adhesive, and a plurality of microspheres disposed between and at least partially within each of the first and second layers of pressure sensitive adhesive.

### BRIEF DESCRIPTION OF THE DRAWINGS

FIG. 1 is a cross-sectional elevation view of an unsealed beaded clear layer.

FIG. 2 is a cross-sectional elevation view of a beaded clear layer.

FIG. 3 is another cross-sectional elevation view of the beaded clear layer of FIG. 2.

FIG. 4A, FIG. 4B, and FIG. 4C are cross-sectional elevation views of portions of different configurations of the beaded clear layer of FIG. 2.

FIG. 5 is a cross-sectional elevation view of another beaded clear layer.

FIG. 6 is another cross-sectional elevation view of the beaded clear layer of FIG. 5.

FIG. 7 is a cross-sectional elevation view of an optical film including the beaded clear layer of FIG. 2.

FIG. 8 is a cross-sectional elevation view of an optical film including the beaded clear layer of FIG. 5.

FIG. 9 is another cross-sectional elevation view of the film of FIG. 7.

FIG. 10 is a schematic of an experimental configuration used to measure optical properties of beaded clear layers.

### DETAILED DESCRIPTION

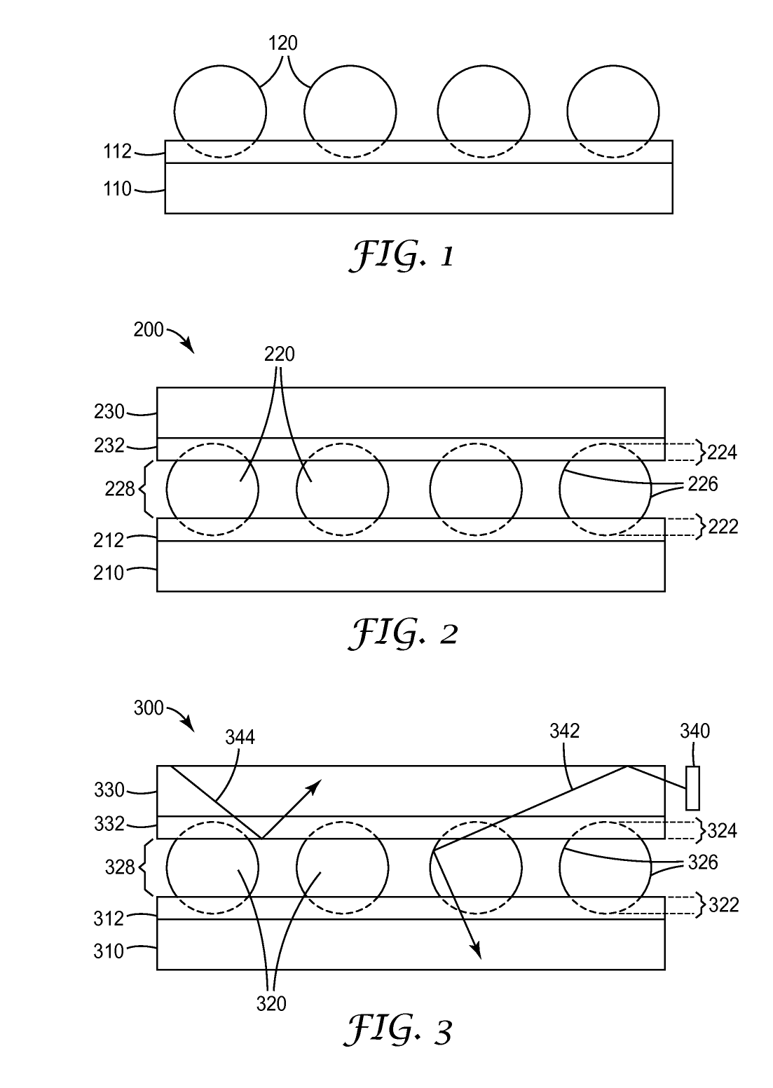

FIG. 1 is a cross-sectional view of an unsealed beaded clear layer. Substrate 110 includes a layer of adhesive 112, in which beads 120 are embedded. Dotted lines on portions of beads 120 indicate the portion of the beads which are wetted out by or otherwise embedded in adhesive 112.

Substrate 110 can be any suitable shape, including curved, planar, or portions of each, and it can be formed from or include any suitable material. In some embodiments, substrate 110 is formed from polycarbonate, polyethylene naphthalate (PEN), polyethylene terephthalate (PET), or any other suitable polymer, copolymer, or combination thereof. In some embodiments, substrate 110 has low haze, high clarity, and high transmission, or it may be optically transparent. The material of substrate 110 may also be selected for other physical or optical properties, such as resistance to warping, dimensional stability, ease of lamination or adherence to other surfaces, or tolerance of certain processing conditions. Substrate 110 may also be any suitable thickness depending on the desired application of the beaded clear layer.

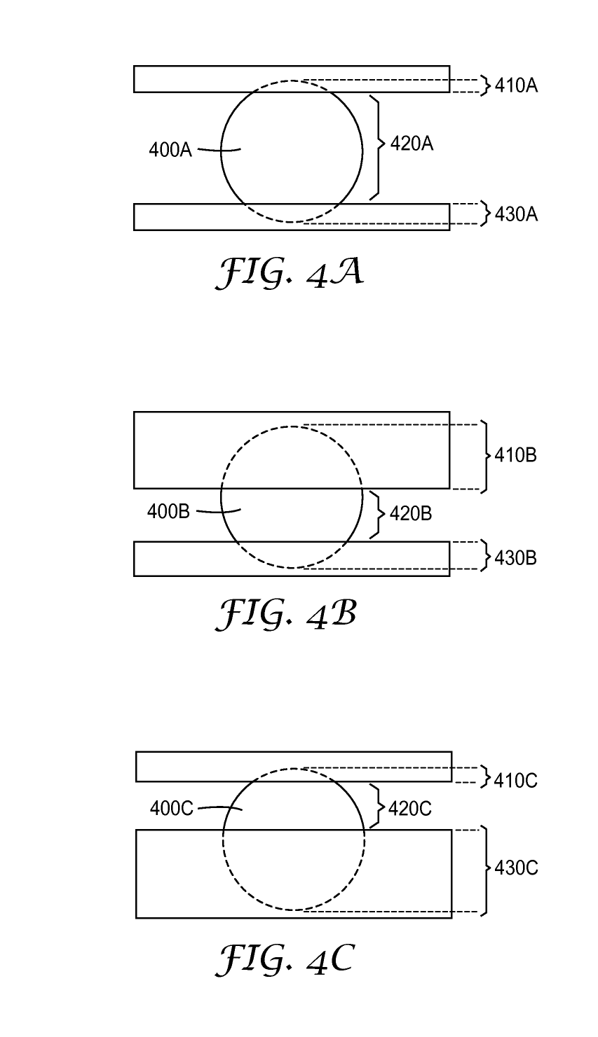

Adhesive 112 is applied or attached to substrate 110 and may be any suitable adhesive, including pressure sensitive adhesives. Adhesive 112 may be of any suitable thickness, and, as described further below in conjunction with FIG. 4A-4C, the selection of this thickness may affect the optical properties of a beaded clear layer. Adhesive 112 may be an optically clear adhesive, a pressure sensitive adhesive, or an adhesive that otherwise imparts low haze, has high clarity, or has high transmission. Adhesive 112 may be selected for its viscosity, thermal properties, flexibility, durability, or other processing and manufacturing considerations. In some embodiments, adhesive 112 may be selected to have the same or substantially a similar index of refraction as substrate 110.

Beads 120 may be any suitable shape and size and may include any suitable material. While beads 120 are shown as substantially spherical in FIG. 1, the illustration is merely exemplary and beads 120 can be any shape, including ellipsoids, oblate or prolate spheroids, prisms, polyhedrons, or even irregularly shaped solids. The beads can be made from any suitable organic or inorganic material, including acrylic, polystyrene, and poly(methyl methacrylate). In some embodiments, the beads are of uniform or nearly uniform size; in other embodiments, the beads exhibit a uniform, Gaussian, or random distribution over a range of sizes. In some embodiments, one of more of beads 120 is at least partially embedded in adhesive 112. Beads 120 may be selected to have any suitable index of refraction. In some embodiments, beads 120 are selected to have an index of refraction substantially the same as adhesive 112, as substrate 110, or as both. In some embodiments, the difference in index of refraction between beads 120 and either or both of adhesive 112 or substrate 110 may be 0.1 or less. Beads 120 may be applied to adhesive 112 by coating beads in a suspension onto the adhesive, or by dry coating beads onto the surface of adhesive 112. In some embodiments, beads 120 may be predispersed throughout adhesive 112, eliminating the necessity for separate application; in these cases, beads 120 are applied along with adhesive 112. The concentration or density of beads during their application may be calculated to provide a monolayer of beads, though multiple layers of beads may not necessarily frustrate the optical effects of the presently described optical layers.

FIG. 2 is a cross-sectional elevation view of a beaded clear layer. Beaded clear layer 200 includes substrate 210, bottom adhesive 212, beads 220, sealing layer 230, and top adhesive 232. Beads 220 include bottom embedded portion 222, top embedded portion 224, and surfaces 226 forming an interface with air gap 228. Beaded clear layer 200 may be formed when sealing layer 230, including top adhesive 232, is laminated or otherwise attached to the unsealed beaded clear layer depicted in FIG. 1.

Substrate 210 and sealing layer 230 may each be formed from any suitable material and be any suitable shape and thickness, as described above for substrate 110 of FIG. 1. In some embodiments, it may be desirable for substrate 210 and sealing layer 230 to be made from the same material or have the same or similar optical properties. In other embodiments, substrate 210 and sealing layer 230 may have different optical properties, be of different thicknesses, or be made from different materials, for example, to allow for quick visual differentiation between the top and bottom of a beaded clear layer. The terms “top” and “bottom” are used for ease of explanation and illustration, and generally such labels will have no effect on the description or optical properties of beaded clear layers described.

In some embodiments, beads 220 are at least partially embedded in both bottom adhesive 212 and top adhesive 232. The top or bottom portion of beads 220 may be wetted out or otherwise embedded in its corresponding adhesive layer. Top embedded portion 224 and bottom embedded portion 222 may be the same or different. The portion of beads not embedded in the adhesive layers includes surfaces 226 incident on air gap 228. The size of air gap 228 depends on the size and shape of beads 220, bottom embedded portion 222, and top embedded portion 224, and often depends on the thickness of bottom adhesive 212 and top adhesive 232. Though air gap 228 is depicted as being planar in FIG. 2, small deviations from the illustrated shape, e.g., a slight dip between one or more of beads 220, are possible (due to, in some cases, adhesion or flow properties of bottom adhesive 212 or top adhesive 232) without detracting from the functionality or operation of the described beaded clear layer. Moreover, air gap 228 need not be filled with air, but may in some embodiments instead be filled with a low-index ink, adhesive, material, or other suitable substance.

Because heating, curing, or other high-temperature steps are not necessary in the formation and sealing of beaded clear layer 200, the layer may avoid or limit the consequences of such processing steps, such as shrinkage, brittleness, yellowing, or stress-induced defects. Apart from physical differences like durability or flexibility, assembly of such beaded clear layers may be more cost effective to manufacture.

FIG. 3 is another cross-sectional elevation view of the beaded clear layer of FIG. 2, illustrating the general operational principles of an embodiment of the present disclosure. As in FIG. 2, beaded clear layer 300 includes substrate 310, bottom adhesive 312, beads 320, sealing layer 330, and top adhesive 332. Beads 320 include bottom embedded portion 322, top embedded portion 324, and surfaces 326 forming an interface with air gap 328. FIG. 3 also depicts light source 340, first light ray 342, and second light ray 344.

Light source 340 may be any suitable light source and may include suitable optics for collimating and injecting light into sealing layer 330 (in such embodiments, sealing layer 330 may act as a lightguide). Light source 340 may include one or more light sources (though depicted as a single element for ease of illustration), including colored or white light emitting diodes (LED), compact fluorescent bulbs, cold-cathode compact fluorescent lamps (CCFLs), incandescent light bulbs, or even ambient light. In some embodiments, light source 340 may include suitable filters or phosphors.

First light ray 342, used to illustrate the general optical operation of one embodiment, may be emitted from light source 340 and may propagate within sealing layer 330. In some embodiments, sealing layer may be bordered on one side by air or some other lower-index layer or material, resulting in supercritical light (i.e., light having an angle of incidence greater than the critical angle given by Snell's Law) being reflected through total internal reflection (TIR). First light ray 342 is depicted as being reflected in sealing layer 330 through TIR once in FIG. 3.

First light ray 342 is then incident on top adhesive layer 332. Top adhesive 332 may be selected to have the same or similar index of refraction as sealing layer 330, in some cases, the difference between the indices of refraction of sealing layer 330 and top adhesive layer 332 may be less than 0.1 to minimize or eliminate refraction of incident rays. In FIG. 3, first light ray 342 is refracted either insignificantly or not at all at the interface between sealing layer 330 and top adhesive 332.

First light ray 342 is next incident on one of beads 320 at top embedded portion 324. In some embodiments, because beads 320 may be selected to have the same or similar indices of refraction as top adhesive layer 332 (viz., a difference of less than 0.1), the top surface included in top embedded portion 324 may be of little or no optical consequence to the behavior of first light ray 342. In other words, beads 320 with wetted-out top embedded portion 324, may be optically equivalent to truncated beads. Still, while in some embodiments, top embedded portion 324 may have no effect on the optical functionality of the beaded clear layer, it may be used to provide other physical, structural, or manufacturing benefits. For example, embedding beads 320 within top adhesive 332 may help prevent or resist delamination of the beaded clear layer.

Next, first light ray 342 is incident on the main portion of one of beads 320, corresponding to air gap 328. Because air has, by definition, an index of refraction of 1, supercritical light will be reflected through TIR at the interface between surfaces 326 and air within air gap 328. In this application, surfaces 326 and its analogues refer to those surfaces of beads 320 which form an interface with air. Depending on the specific size and geometry of beads 320, light incident on surfaces 326 may be reflected entirely or predominantly within a certain angular range. In some embodiments, light normal to a surface of the beaded clear layer may be optimal for observation by a viewer and very high angle light (near 90° from normal) may be limited or eliminated. The degree to which each of beads 320 is embedded within the top and bottom adhesives may have a significant effect on the shape of surfaces 326 (discussed below with aid of FIG. 4A-4C) and, consequently, on the angular range of light reflected from those surfaces.

After being reflected by surfaces 326, first light ray 342 may pass through bottom embedded portion 322, bottom adhesive 312, and substrate 310. Like top embedded portion 324 and top adhesive layer 332, the indices of refraction of the bottom embedded portion, bottom adhesive, and substrate may be selected to be the same or similar to beads 320, in order to minimize refraction or other redirection of incident light. In some embodiments, first light ray 342 may be emitted through an external surface of substrate 310 and be observed by a viewer. In other embodiments, first light ray 342 may illuminate a graphic or display.

Second light ray 344, like first light ray 342, passes from sealing layer 330 into top adhesive layer 332 without being significantly or even at all refracted. Second light ray 344, however, is not next incident on any of beads 320, and, instead, is supercritically incident on air gap 328 and reflected back into sealing layer 330. Because some light rays are reflected back into sealing layer 330 while some light rays are extracted through to substrate 310, beaded clear layer 300 may be referred to as an extraction layer, or at least that it performs the function of extracting light. Likewise, because light extracted through beads 326 may be selectively redirected or otherwise angularly limited, beaded clear layer 300 may also be referred to as a turning layer, or at least that it performs the function of turning light.

FIG. 4A, FIG. 4B, and FIG. 4C are cross-sectional elevation views of portions of different configurations of the beaded clear layer, showing different thicknesses of adhesives and depths that the beads are embedded within said adhesives. Each of FIG. 4A, FIG. 4B, and FIG. 4C includes bead 400, top embedded portion 410, air gap 420, and bottom embedded portion 430, appended in each figure with A, B, or C, respectively. In each, the beaded clear layer is configured such that a different cross section of the embedded bead 400 is included in air gap 420. The depth of embedding (in other words, the sizes of each 410 and 430) may depend on the layer thickness of the top and bottom adhesives, it may depend on physical or structural properties of the adhesive itself, or it may depend on various processing factors, such as processing temperature or laminating pressure when forming the beaded clear layer.

For example, in FIG. 4A, top embedded portion 410A is smaller than bottom embedded portion 430A, though the thicknesses of the top and bottom adhesives are of similar thickness. In contrast, in FIG. 4B, the top adhesive is far thicker than the bottom adhesive, which may result in top embedded portion 410B being much larger than bottom embedded portion 430B. The portion of bead 400B that corresponds with air gap 420B is much different in this example than those of FIG. 4A, viz., 400A corresponding with 420A. Likewise, in FIG. 4C, the bottom adhesive is much thicker than the top adhesive, which may result in bottom embedded portion 430C being much larger than top embedded portion. The portion of bead 400C that corresponds with air gap 420C is also much different than corresponding parts either of FIG. 4A or FIG. 4B.

The portion of bead 400 that corresponds with air gap 420 affects the shape of surfaces 326, shown in FIG. 3. With reference to FIG. 3, extracted light may reflect off the surfaces 326 of beads 320. Different shapes for surfaces 326 may affect the angular profile of reflected light. In some embodiments, the shape of surfaces 326 may be selected through configuring the beaded clear layer in a suitable arrangement; for example, as a cross section shown in FIG. 4.

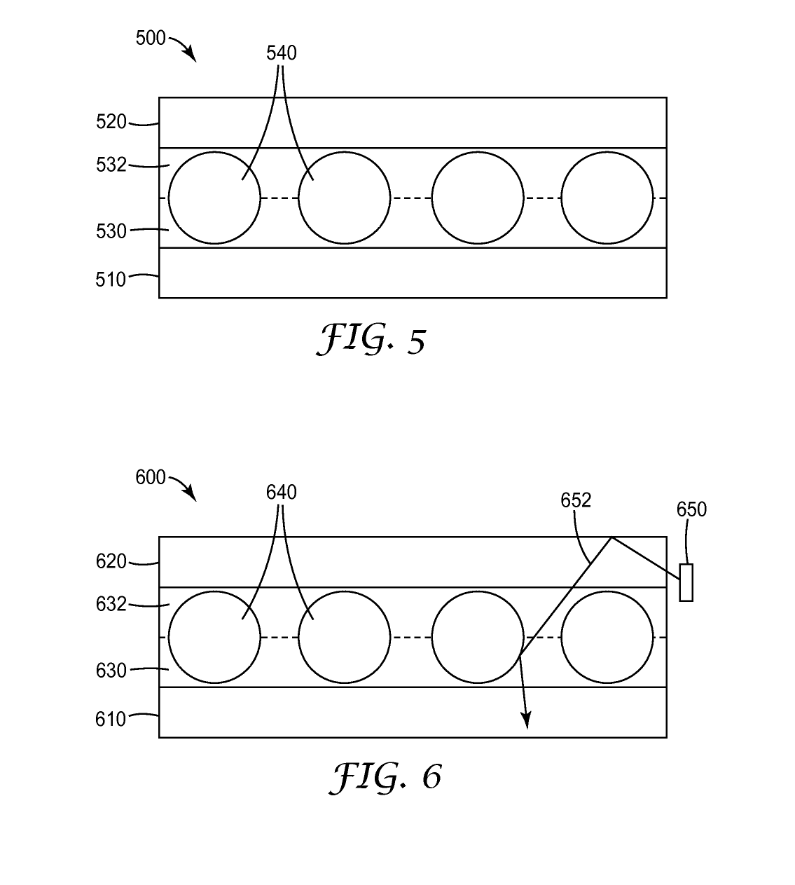

FIG. 5 is a cross-sectional elevation view of another beaded clear layer. Beaded clear layer 500 includes substrate 510, sealing layer 520, bottom adhesive 530, top adhesive 532, and beads 540. In these embodiments, there is no air gap between bottom adhesive 530 and top adhesive 532.

Substrate 510 and sealing layer 520 may be made from any suitable material, may be the same or different, and may have any suitable shape or thickness, as described in more detail above for substrate 110 of FIG. 1. Bottom adhesive 530 and top adhesive 532 may each or both be any suitable adhesive, including optically clear adhesives and pressure sensitive adhesives. The dashed line in FIG. 5 separating bottom adhesive 520 and top adhesive 532 represents an approximate boundary between the two adhesive layers. Depending on the physical and structural properties of either adhesive, the boundary may not be strictly linear, but instead may include jagged, curved, sagging or bulging segments. Further, though the dashed line in FIG. 5 suggests the adhesives are approximately equal in thickness, bottom adhesive 530 and top adhesive 532 may be any suitable thickness, whether the same or different. In some embodiments, bottom adhesive 530 and top adhesive 532 may be the same adhesive or optically equivalent, making it difficult or impossible to identify a boundary between bottom adhesive 530 and top adhesive 532. In other words, in some embodiments, bottom adhesive 530 and top adhesive 532 may behave as if there were only a single adhesive between substrate 510 and sealing layer 520.

Bottom adhesive 530 and top adhesive 532 may have an index of refraction selected to the same or similar to substrate 510 and sealing layer 520, respectively. In some embodiments, the difference between the refractive indices of sealing layer 520 and top adhesive 532 (and correspondingly, between substrate 510 and bottom adhesive 530) may be less than 0.1, depending on desired or acceptable refraction or total internal reflection.

Beads 540, as in FIGS. 1-4, may be of any suitable material, may be any suitable size, shape, or distribution thereof, and may be spaced or arranged within bottom adhesive 530 and top adhesive 532 in any manner, including randomly. In some embodiments beads 540 are formed from a low-index material, i.e., a material with an index of refraction less than 1.4, 1.3, 1.25, or 1.2. The material, and consequently, the index of refraction, of beads 540 may be selected to be sufficiently lower than bottom adhesive 530 or top adhesive 532, such that supercritical light rays incident on the surface of the beads are at least partially reflected through TIR. In some embodiments, the index of refraction of beads 540 may be 0.1, 0.15, 0.2, or 0.25 less than bottom adhesive 530 or top adhesive 532.

FIG. 6 is another cross-sectional elevation view of the beaded clear layer of FIG. 5, illustrating its general operational principles. Beaded clear layer 600 includes the features of FIG. 5, namely, substrate 610, sealing layer 620, bottom adhesive 630, top adhesive 632, and beads 640, described in more detail above. FIG. 6 also includes light source 650 and light ray 652.

In order to trace the general optical properties of certain embodiments, light ray 652 is depicted as emitted or otherwise directed from light source 650. Light source 650 may be any suitable component or sets of components, described in more detail above for light source 340 in FIG. 3. Light ray 652 enters or is otherwise injected into sealing layer 620. Sealing layer 620 may function as a lightguide; in other words, light may continue to propagate within sealing layer 620 by being reflected through TIR. Sealing layer 620 may include suitable coatings, possess suitable geometry, or be disposed adjacent to or optically coupled to layers with suitable indices of refraction in order to allow light to propagate along its length.

While the configuration of FIG. 6 is depicted as being edge-lit, that is, light enters beaded clear layer 600 through sealing layer 620 from a light source disposed proximate a side or edge, beaded clear layer 600 is not limited to this configuration. In some embodiments, light source 650 may be disposed proximate substrate 610 and substrate 610 may function as a light guide. In other embodiments, light source 650 may be directly in behind or in front of beaded clear layer 600; in other words, beaded clear layer 600 may be backlit. In these embodiments, it may not be desirable for one or both of substrate 610 and sealing layer 620 to function as a lightguide.

Light ray 652 is incident on top adhesive 632. In some embodiments, because top adhesive 632 and sealing layer 620 may have the same or similar indices of refraction, light ray 652 may be negligibly or not at all refracted when passing from one medium to the other. Likewise, when light ray 652 crosses the dashed line representing the approximate boundary between bottom adhesive 630 and top adhesive 632, light ray 652 may be refracted negligibly or not at all due to the selection of refractive indices for the two adhesive layers. Alternatively, light ray 652 may not be refracted or otherwise redirected because bottom adhesive 630 and top adhesive 632 may be the same material or, they may possess the same optical properties.

Next, light ray 652 is incident on one of beads 640. The index of refraction of beads 640 may be selected to be sufficiently lower than bottom adhesive 630 or top adhesive 632, such that supercritical light rays incident on the surface of the beads are at least partially reflected through TIR. The shape of beads 640 may have a significant effect on the reflection or other redirection of light ray 652. More specifically, because light ray 652 may be reflected off beads 640 as if it were reflected off a plane tangent to the surface at the point of incidence, different shapes may give different distributions of possible reflection angles for incident light. Because light reflected by beads 640 may be selectively redirected or otherwise angularly limited, beaded clear layer 600 may be referred to as a turning layer, or at least that it performs the function of turning light.

After being reflected by beads 640, light ray 652 may enter substrate 610. As illustrated in FIG. 6, light ray 652, incident on the boundary between bottom adhesive 630 and substrate 610, may not undergo significant refraction, and in some cases none at all. In other words, the refractive indices of substrate 610 and bottom adhesive 630 may be similar enough such that little or no refraction occurs as light crosses from one medium to the other. Once light ray 652 enters substrate 610, it may cross into or interact with other layers or optical elements not shown in FIG. 6, including turning films, diffusers, prism films, lenses, or any other suitable optics or combinations of optics. In some embodiments, substrate 610 may function as a lightguide and light ray 652 may propagate within it. In some embodiments, light ray 652 may be transmitted through or otherwise extracted through a surface of substrate 610 where it may be observed by a viewer.

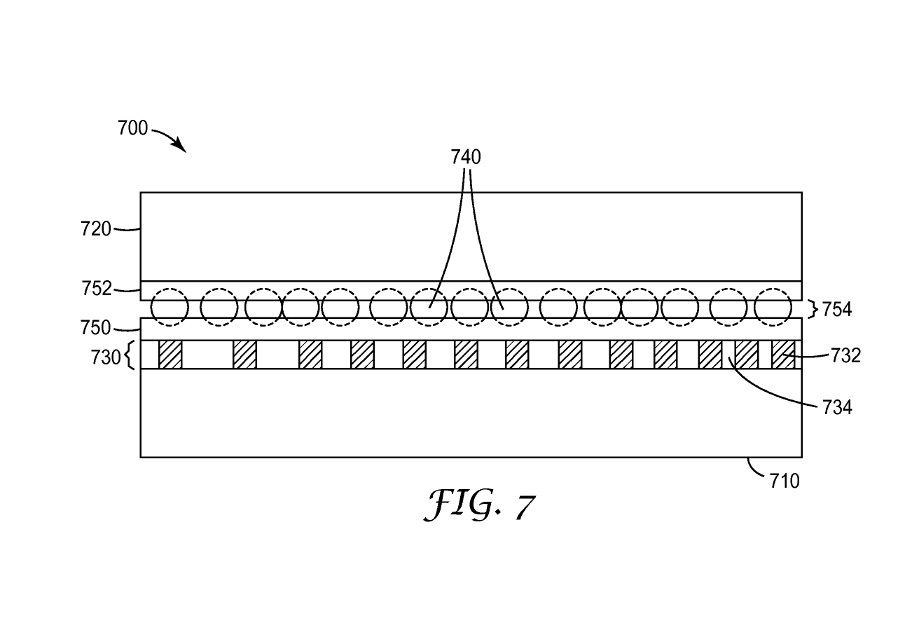

FIG. 7 is a cross-sectional elevation view of an optical film including the beaded clear layer of FIG. 2. Optical film 700 includes substrate 710, sealing layer 720, light extraction layer 730, including extraction regions 732 and non-extraction regions 734, beads 740, bottom adhesive 750, top adhesive 752, and air gap 754. Essentially, optical film 700 is very similar to beaded clear layer 200 (shown in FIG. 2), with the exception of the included light extraction layer between substrate 710 and bottom adhesive 750.

In some embodiments, particularly where beads 740 perform the function of extraction, it may be difficult or impractical, or prohibitively costly to reliably organize or arrange beads 740 in a gradient or other pattern. For example, for beaded clear layers illuminated by edge-lit light sources, it may be desirable to limit extraction close to the light source (to avoid bright spots) and increase it as a function of distance from the source. Because, assuming equal size beads, the number of beads in a region is proportional to the amount of light extracted from that region, it may be desirable to provide a specific distribution of beads in cases where a uniform light output is preferred. While beads 740 may technically still perform the function of extraction—that is, light is selectively passed through beads 740 (as illustrated in FIG. 3)—the inclusion of light extraction layer 730 distributes that function between light extraction layer 730 and beads 740. The inclusion of light extraction layer 730 may hedge against the risk of uneven distribution of beads 740. More specifically, including light extraction layer 730 to selectively extract light may provide the desired light uniformity even with a random distribution of beads. Nonetheless, beads 740 may also still perform the function of turning light, particularly where light extraction layer 730 is not configured or optimized to do so.

Light extraction layer 730 may have any suitable configuration. In some embodiments, light extraction layer 730 may include alternating extraction regions 732 and non-extraction regions 734. Extraction regions 732 may include any number of extraction features, including diffusely reflective printed dots; etches; prisms, lenslets, or arrays or combinations of either; high-index material or substance (compared to adjacent regions). Conversely, non-extraction regions 734 may have any number of features that prevent light from being transmitted through light extraction layer 730. For example, non-extraction regions 734 may include areas of low-index materials or substance (compared to adjacent regions), absorptive material, or even opaque or otherwise optically non-transmissive material or substances. In some embodiments, non-extraction regions 734 may include regions of air or another gas.

Light extraction layer 730 may be a variable index light extraction layer, that is, it may include alternating regions with high and low indices of refraction. In some embodiments, light extraction layer 730 may include microreplicated posts, with a high index substance printed in, as described, for example, in U.S. Provisional Patent Application Ser. No. 61/655,208, entitled “Variable Index Light Extraction Layer with Microreplicated Posts and Methods of Making the Same,” and filed Jun. 4, 2012, or light extraction layer 730 may include a nanoporous material, including a nanovoided polymeric material described, for example, in U.S. Patent Application Ser. No. 61/446,740, entitled “Front-Lit Reflective Display Device and Method of Front-Lighting Reflective Display,” and filed Feb. 25, 2011.

In some embodiments, light extraction layer 730 may include other films or substrates; for example, light extraction layer 730 may be a sealed film laminated to substrate 710 with a suitable adhesive, such as a pressure sensitive or optically clear adhesive. Light extraction layer 730 may also be formed on or be part of substrate 710. It should be apparent to one with skill in the art that these may be design and manufacturing choices, and likely would have little to no significant effect on the optics of the presently described beaded clear layer.

Extraction regions 732 may be selected have the same or similar index of refraction as substrate 710 or bottom adhesive 750; in some cases, the difference between the indices of refraction of extraction regions 732 and adjacent layers (excluding non-extraction layers 734) may be less than 0.1 to minimize or eliminate refraction of incident rays. Index-matching or specific selection of materials by their index of refraction may be useful in embodiments where minimizing distortion and the scattering of light are desirable.

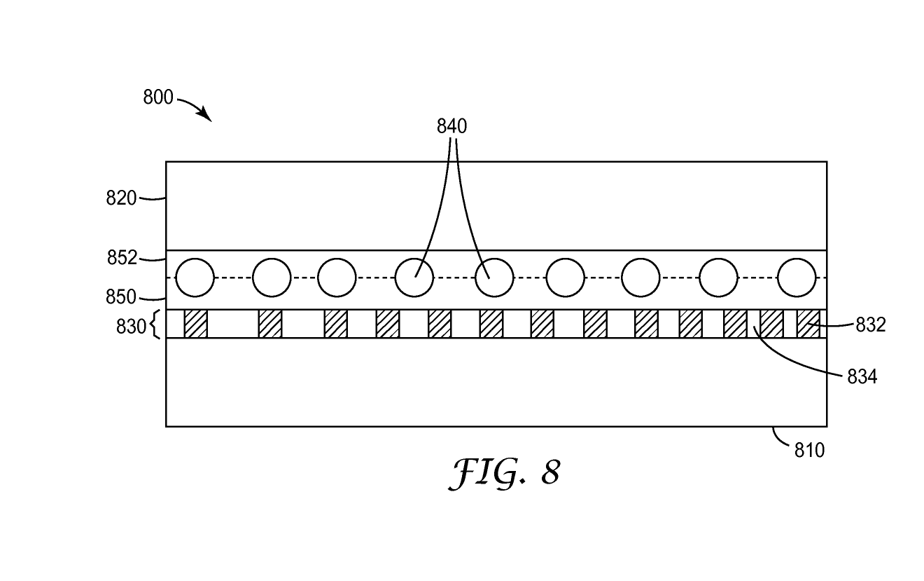

FIG. 8 is a cross-sectional elevation view of an optical film including the beaded clear layer of FIG. 5. Optical film 800 includes substrate 810, sealing layer 820, light extraction layer 830, including extraction regions 832 and non-extraction regions 834, beads 840, bottom adhesive 850, and top adhesive 852. Essentially, optical film 800 is very similar to beaded clear layer 500 (shown in FIG. 5), with the exception of the included light extraction layer between substrate 810 and bottom adhesive 850.

As described above in conjunction with FIG. 7, light extraction layer 830 may perform the function of extraction, permitting in some embodiments a more uniform output of light. Beads 840, however, in the configuration shown in FIG. 8, do not share in the function of extraction; rather, they only perform the function of turning. In other words, the configuration of extraction regions 832 and non-extraction 834 are primarily responsible for the extraction of light, regardless of the arrangement of beads 840. Beads 840 may have low indices of refraction, allowing light to be reflected or otherwise redirected after being incident on their surfaces. Light extraction layer 830 may have the same or similar properties as described for light extraction layer 730 of FIG. 7, including being a variable index light extraction layer or a nanoporous material with a printed-in ink or other material.

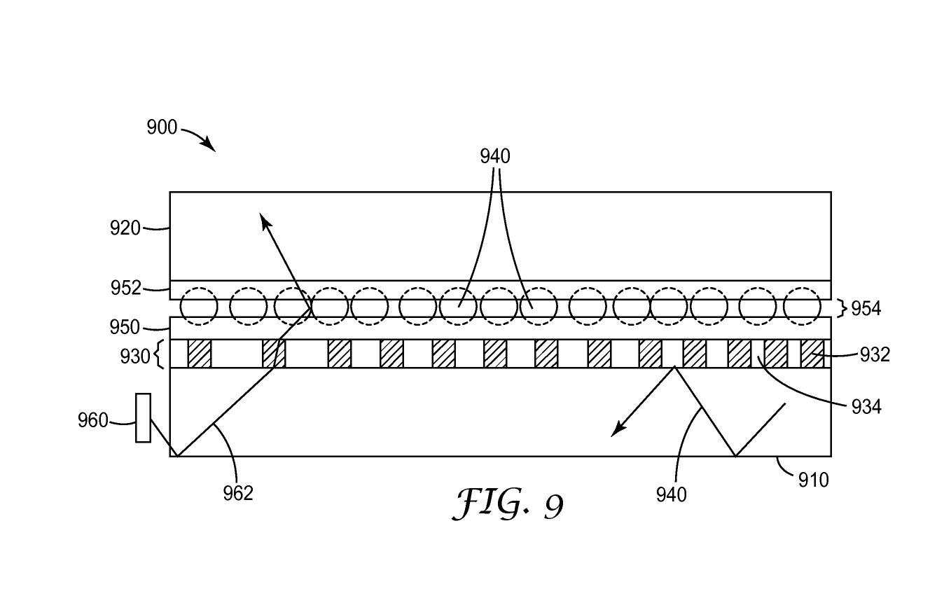

FIG. 9 is another cross-sectional elevation view of the film of FIG. 7. Optical film 900 includes substrate 910, sealing layer 920, light extraction layer 930 including extraction regions 932 and non-extraction regions 934, beads 940, bottom adhesive 950, top adhesive 952, air gap 954, light source 960, first ray 962, and second ray 964. Essentially, optical film 900 is identical to optical film 700 (shown in FIG. 7), with the exception of the included light source 960, first light ray 962, and second light ray 964.

Light source 960 may be any suitable light source, including appropriate optics, including those described above in conjunction with FIG. 3. Because light source 960 is depicted as being disposed on the left side of substrate 910, the gradient pattern of extraction regions 932 and non-extraction regions 934 (increasing in extraction density from left to right) may help create a more uniform output light by increasing extraction with distance to the light source. Were light source 960 disposed on the right side of substrate 910, the gradient pattern of light extraction layer 930 may be ineffective in increasing uniform output light, and may even exacerbate non-uniformity.

To illustrate the general optical function and properties of optical film 900, first light ray 962 is depicted as being emitted from light source 960. First light ray 962 is somehow introduced into substrate 910 (which in this illustrated embodiment functions as a lightguide), possibly including through suitable injection optics or optical coupling. First light ray 962 travels through substrate 910 and is incident on light extraction layer 930, more specifically at a portion of extraction regions 932.

Because extraction regions 932 may be selected to have a similar or higher index of refraction than adjacent substrate 910, first light ray 962 may be extracted; that is, in this case, it may pass through without being reflected through TIR. In FIG. 9, extraction regions 932 is depicted as having a higher index of refraction than substrate 910; therefore, first light ray 962 is refracted as it passes through the higher-index medium of extraction regions 932. While in practice, light rays incident on extraction regions 932 may be partially reflected and partially refracted (in other words, they may only be partially extracted), this may be acceptable depending on the desired application, and in any case does not significantly impact the functionality or operation of optical film 900.

As first light ray 962 passes into lower index of refraction bottom adhesive 950 (relative to the index of refraction of extraction regions 932), it may be refracted back to its original trajectory, as depicted in FIG. 9. First light ray 962 is then incident on beads 940, which may be selected to have a similar or higher index than the adjacent bottom adhesive 950. In FIG. 9, first light ray 962 is not significantly refracted or reflected as it passes into one of beads 940, suggesting beads 940 have the same or similar index of refraction as bottom adhesive 950.

First light ray 962 is then incident on the air/bead interface corresponding to air gap 954. Because air has an index of refraction of 1, the index of refraction of beads 940 will necessarily be greater than, sometimes much greater than, that of air corresponding with air gap 954. As supercritical light, first light ray 962 is totally internally reflected at the air/bead interface corresponding with air gap 954. Depending on the shape, embedding, and cross-sectional profile of beads 940 corresponding with air gap 954, beads 940 may perform the function of turning light, that is, limiting or changing the angles at which it emerges from beads 940 and ultimately through sealing layer 920.

In FIG. 9, beads 940 may have the same or similar index of refraction as top adhesive 952 and sealing layer 920. As illustrated, first light ray 962 continues without redirection through the interface of beads 940 and top adhesive 952 and through the interface of top adhesive 952 and sealing layer 920, though top adhesive 952 and sealing layer 920 may refract or otherwise redirect first light ray 962 without departing from the scope of optical film 900 and its functions. In other words, beads 940, top adhesive 952, and sealing layer 920 need not be index matched. In some embodiments, however, the indices of refraction of sealing layer 920, beads 940, bottom adhesive 950, and top adhesive 952 are selected to minimize reflection or undesired refraction, thereby preserving efficiency while preventing light leakage or other potential artifacts. First light ray 962 may continue through sealing layer 920 and may, in some embodiments, be thereafter observed by a viewer. In other embodiments, optical film 900 may be part of an optical system, such as a display, first light ray 962 may not immediately be observed by a viewer through a surface of sealing layer 920.

In contrast to first light ray 962, second light ray 964 is shown from an arbitrary starting point propagating within sealing layer 910, which is functioning as a light guide. Second light ray 964 is also incident on light extraction layer 930, but is more specifically incident on a portion of non-extraction regions 932. Non-extraction regions may prevent light from being transmitted through total internal reflection. In other words, in some embodiments non-extraction regions 934 may have a lower or much lower index of refraction relative to adjacent substrate layer 910. If second light ray 964 is incident on a portion of non-extraction regions 934 at a supercritical angle, as illustrated in FIG. 9, second light ray 964 will be totally internally reflected and will continue propagating within substrate 910, perhaps until being incident on a portion of extraction regions 932.

Beaded clear layers and optical films described above may be useful in many situations, particularly in those where a low-haze, low-distortion surface is desirable. Because beaded clear layers and optical films described herein may appear transparent, these layers may be utilized to transform traditionally transparent surfaces (e.g., windows, transparent counters, skylights, sunroofs) into surfaces with display or illumination capability. Similarly, beaded clear layers and optical films described above may be combined with display surfaces, such as transparent display surfaces, to more uniformly extract light from, for example, a transparent LCD display. Described optical films and beaded clear layers may also be useful for luminaires, lamps, and other general lighting applications, especially in uses where greater flexibility may be desired or required. Flexible embodiments may be easily bendable without creasing, tearing, breaking, snapping, or delamination and may be useful in applications utilizing curved or other nonplanar shapes.

All U.S. patent applications cited in the present application are incorporated herein by reference as if fully set forth. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

### EXAMPLES

Optical film samples were made and tested to show turning effect while maintaining acceptable clarity and haze values. These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted.

### Materials:

| Abbreviation | Description |
|---|---|
| Bead 1 | CA-6 (6 m), Spheromers PMMA beads, available |
| | from Microbeads AS, Skedsmokorset, Norway. |
| Bead 2 | CA-10 (10 m), Spheromers PMMA beads, available |
| | from Microbeads AS, Skedsmokorset, Norway. |
| Bead 3 | CA-15 (15 m), Spheromers PMMA beads, available |
| | from Microbeads AS, Skedsmokorset, Norway. |
| ALG | Adhesive Light Guide consisting of 2 mm thick |
| | VHB #4918 adhesive available from 3M Company, |
| | St. Paul, MN with a 25 m Polyurethane carrier film |
| | on one side. |
| PSA | Polymer PSA solution of 2 Methyl Butyl Acrylate |
| | (2MBA)/acrylic acid (AA) (90/10) prepared as described |
| | in US Patent RE 24,906 (Ulrich). |
| VILEF | Variable Index Light Extraction Film consisting |
| | of 50 μm PET film with 2 μm nanovoided |
| | polymeric layer patterned with 0P1005 UV FLEXO |
| | Varnish (Nazdar, Shawnee, KS) filling portions of |
| | the nanovoided layer. Prepared as described in PCT |
| | application WO 2012/116129 (Schaffer). |

### Test Methods

### Transmission, Clarity, and Haze Measurements

Transmission, clarity and haze values were obtained for samples using a HAZE-GARD PLUS hazemeter, made by BYK-Gardner USA, Columbia, Md. Samples were held in front of the HT port of the hazemeter. Test button was pushed, and % transmission, % haze, and % clarity values were recorded in Table 1.

### Luminance Measurements

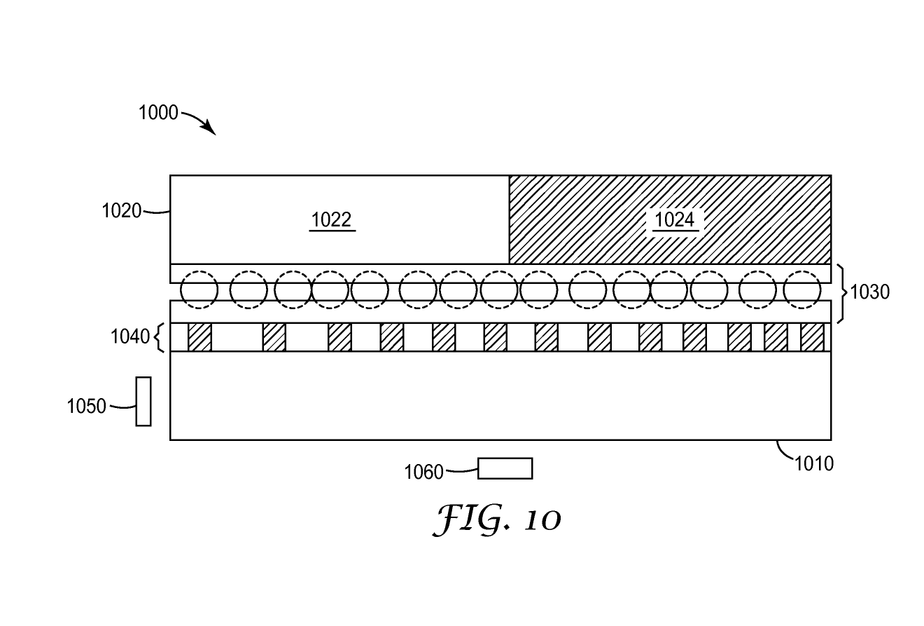

FIG. 10 is a schematic cross-section view of the experimental set-up, largely corresponding to FIGS. 7 and 9. The optical construction 1000 includes lightguide 1010 and top film 1020 including white region 1022 and black region 1024 sandwiching embedded bead layer 1030 and variable index light extraction layer 1040. One or more LEDs 1050 is disposed to inject light into lightguide 1010 and sensor 1060 is configured and positioned to receive light reflected by top film 1020. LEDs (Model # wwrfev-Reel/Narrow Dimmable Edge-View LED Ribbon Flex available from Environmental Lights, San Diego, Calif.) (1050) were placed on the edge of the adhesive light guide (1010). Luminance readings were taken corresponding to the white (1022) and black (1024) background regions of the samples. Luminance values were obtained for samples using a Radiant Imaging PROMETRIC camera PM 1613F-1, made by Radiant Zemax Corp, Redmond, Wash. (1060). The ratio between these values was calculated and is shown as the contrast ration in Table 1.

### EXAMPLES

### Adhesive Layer

The adhesive layer was prepared as follows: PSA was diluted with isopropyl alcohol as a solvent and brought to a 10% solution. A bottle of the mixture was rolled on a roller mixer for 1 hour. Mixing was done at room temperature. The resultant mixture was coated onto a 50 μm PET film. The film and PSA were placed in a marble top knife coater, which was gapped to yield 1, 3, 5, and 7 micron dry coating thickness. The coatings were placed in the solvent oven for 5-10 minutes at 70° C. to dry.

### Bead Layer

Three different bead solutions were prepared containing 15% of Bead 1, Bead 2, and Bead 3 in isopropyl alcohol. These were stirred and shaken until the beads were suspended uniformly in the solvent. This suspension was coated using #6 Mayer bar on different thicknesses of adhesive (see Table 1) to obtain a monolayer of beads. The coatings were dried in an oven of 85 C for 1 minute. Another layer of adhesive was laminated (using CATENA 35 laminator available from General Binding Corp. Northbrook, Ill. set to 71 C, speed “5”, “Heavy Gauge Pressure”) on top of this construction, sandwiching the beads in the middle (to form embedded bead layer 1030).

### Sample Construction

One layer of VLEF (1040) was laminated using the CATENA 35 laminator to the PSA, Bead, PSA sandwich (1030). This whole construction was laminated to an ALG (1010). The samples were tested for transmission, haze and clarity using the test method described above. Black (1024) and White (1022) films (3M Scotchcal Graphic Film #3650-10 White and 3M Scotchcal Graphic Film #3650-12 Black available from 3M Company, St. Paul, Minn.) were laminated to the other side of the sandwich. The samples were tested for luminance using the test method described above. Results are recorded in Table 1.

A comparative sample was made without beads and is shown as sample number one in Table 1. One layer of VLEF was laminated using the CATENA 35 laminator to the PSA, PSA sandwich. This whole construction was laminated to an ALG. The sample was tested for transmission, haze and clarity using the test method described above. Black and White films (3M Scotchcal Graphic Film #3650-10 White and 3M Scotchcal Graphic Film #3650-12 Black available from 3M Company, St. Paul, Minn.) were laminated to the other side of the sandwich. The sample was tested for luminance using the test method described above. Results are recorded in Table 1.

TABLE 1
Contrast ratio, haze, transmission and clarity data for different adhesive thickness and beads.

| | Adhesive | | | | Luminance | | | | | |
|---|---|---|---|---|---|---|---|---|---|---|
| | | Top | Bottom | Beads | Black avg | White avg | Contrast ratio | | | |
| No | Adhesive | (μm) | (μm) | (μm) | (Cd/m²) | (Cd/m²) | (White/Black) | % T | Haze | Clarity |
| 1 | PSA | 5 | 3 | No | 26 | 74 | 2.9 | 87 | 5 | 96 |
| | | | | beads | | | | | | |
| 2 | PSA | 1 | 3 | 6 | 46 | 131 | 2.9 | 88 | 28 | 78 |
| 3 | PSA | 3 | 3 | 6 | 26 | 83 | 3.2 | 88 | 28 | 78 |
| 4 | PSA | 7 | 5 | 6 | 18 | 72 | 4.0 | 90 | 22 | 92 |
| 5 | PSA | 7 | 3 | 6 | 16 | 57 | 3.6 | 89 | 22 | 90 |
| 6 | PSA | 3 | 5 | 6 | 18 | 61 | 3.4 | 88 | 23 | 93 |
| 7 | PSA | 3 | 7 | 10 | 35 | 99 | 2.8 | 86 | 20 | 81 |
| 8 | PSA | 5 | 7 | 10 | 33 | 97 | 2.9 | 88 | 26 | 86 |
| 9 | PSA | 7 | 3 | 10 | 31 | 110 | 3.5 | 88 | 24 | 93 |
| 10 | PSA | 5 | 3 | 10 | 18 | 91 | 4.9 | 89 | 22 | 85 |
| 11 | PSA | 7 | 3 | 15 | 29 | 101 | 3.5 | 85 | 46 | 42 |
| 12 | PSA | 7 | 3 | 15 | 25 | 89 | 3.5 | 87 | 35 | 43 |
| 13 | PSA | 7 | 5 | 15 | 23 | 93 | 4.0 | 87 | 28 | 51 |

What is claimed is:

1. An optical film, comprising:
a first layer of pressure sensitive adhesive comprising a first thickness;
a second layer of pressure sensitive adhesive comprising a second thickness; and
a plurality of microspheres comprising a mean diameter, the plurality of microspheres disposed between and at least partially within each of the first and second layers of pressure sensitive adhesive;
wherein the first thickness of the first layer of pressure sensitive adhesive, the second thickness of the second layer of pressure sensitive adhesive, and the mean diameter of the plurality of microspheres have been selected such that the first and second layer of pressure sensitive adhesive are not in contact.

2. The optical film of claim 1, wherein the optical film is flexible.

3. The optical film of claim 1, wherein the first layer of pressure sensitive adhesive comprises a first index of refraction, the second layer of pressure sensitive adhesive comprises a second index of refraction, and the plurality of microspheres comprises a third index of refraction, and wherein the third index of refraction is within 0.1 of both the first index of refraction and the second index of refraction.

4. The optical film of claim 1, further comprising a substance disposed between the first and second layers of pressure sensitive adhesive.

5. The optical film of claim 4, wherein the substance comprises air.

6. The optical film of claim 4, wherein the plurality of microspheres comprises a first index of refraction, and the substance comprises a second index of refraction at least 0.1 less than the first index of refraction.

7. The optical film of claim 1, wherein the mean diameter of the plurality of microspheres is about 10 microns.

8. The optical film of claim 1, wherein the first thickness of the first pressure sensitive adhesive layer is between 1 and 7 microns.

9. An optical film, comprising:
a first layer of pressure sensitive adhesive;
a second layer of pressure sensitive adhesive; and
a plurality of microspheres comprising an index of refraction, the plurality of microspheres disposed between and at least partially within each of the first and second layers of pressure sensitive adhesive;
wherein the index of refraction of the plurality of microspheres has been selected to reflect at least a portion of light incident on the light turning film through total internal reflection without entering the plurality of microspheres.

10. The optical film of claim 9, wherein the first layer of pressure sensitive adhesive and the second layer of pressure sensitive adhesive are the same adhesive.

11. The optical film of claim 9, wherein the first layer of pressure sensitive adhesive and the second layer of pressure sensitive adhesive form a single layer of adhesive.

12. The optical film of claim 9, wherein the index of refraction of the plurality of microspheres is less than 1.4.

13. The optical film of claim 9, wherein the first layer of pressure sensitive adhesive comprises a first index of refraction and the second layer of pressure sensitive adhesive comprises a second index of refraction, and wherein the index of refraction of the plurality of microspheres is at least 0.1 less than either the first index of refraction or the second index of refraction.

14. An optical film, comprising:
an extraction layer comprising a first region and a second region, wherein the first region has a lower effective index of refraction than the second region; and
a turning layer optically coupled to the extraction layer, the turning layer comprising a first layer of pressure sensitive adhesive, a second layer of pressure sensitive adhesive, and plurality of microspheres disposed between and at least partially within each of the first and second layers of pressure sensitive adhesive.

15. The optical film of claim 14, further comprising a lightguide optically coupled to the extraction layer.

16. The optical film of claim 15, wherein the first and second region of the extraction layer are arranged such that the extraction layer extracts guided mode light from the lightguide based on the geometric arrangement of the first and second regions.
